(19) United States
(12) Patent Application Publication
(10) Pub. No.: US 2021/0384547 A1
(43) Pub. Date: Dec. 9, 2021

(54) Light Transmissive Battery and Power Generating Glass

(71) Applicant: Nippon Telegraph and Telephone Corporation, Tokyo (JP)

(72) Inventors: Yoko Ono, Musashino-shi, Tokyo (JP); Hironobu Minowa, Musashino-shi, Tokyo (JP); Shuhei Sakamoto, Musashino-shi, Tokyo (JP); Takeshi Komatsu, Musashino-shi, Tokyo (JP)

(21) Appl. No.: 17/287,230

(22) PCT Filed: Nov. 6, 2019
(86) PCT No.: PCT/JP2019/043371

§ 371 Date: Apr. 21, 2021

(30) Foreign Application Priority Data
Nov. 20, 2018 (JP) 2018-216979

(51) Int. Cl. H01M 10/0525; H01M 10/0585; H01M 4/131; H01M 50/10; H01M 4/64

(52) U.S. Cl. CPC H01M 10/0525; H01M 10/0585; H01M 4/64; H01M 50/10; H01M 4/131

(57) ABSTRACT

Provided is a light-transmissive battery that transmits visible light. A light-transmissive battery includes a positive electrode including an insulating transparent cover body and a positive-electrode current collector layer and a positive electrode layer sequentially stacked over the insulating transparent cover body; a negative electrode including an insulating transparent cover body and a negative-electrode current collector layer and a negative electrode layer sequentially stacked over the insulating transparent cover body; and a transparent electrolyte disposed between the positive electrode layer and the negative electrode layer that are opposed to each other. Each of the positive-electrode current collector layer, the negative-electrode current collector layer, the positive electrode layer, and negative electrode layer is formed to a thickness that allows the layer to transmit visible light.

### TECHNICAL FIELD

The present invention relates to batteries that transmit visible light.

### BACKGROUND ART

Nowadays, lithium ion secondary batteries are widely used as various power supplies mainly for electronic devices. With a significant progress in development of more compact and lighter-weight electronic devices, secondary batteries that are mounted on the electronic devices have also been reduced in size, weight, and thickness. For example, low-profile secondary batteries are used as drive sources for various electronic devices such as smartphones. Batteries are sometimes required to have flexibility and decent designs not only as mobile power supplies but also as power supplies for transparent displays or ultrathin displays, for example.

### CITATION LIST

### Non-Patent Literature

Non-Patent Literature 1: Website of AIST, Article about Research Results: “Success in Prototyping Transparent Solar Cells,” [online], Jun. 25, 2003, The National Institute of Advanced Industrial Science and Technology, [Searched Sep. 7, 2018], the Internet <URL: https://www.aist.go.jp/aist_j/press_release/pr2003/pr20030625/pr20030625.html>

### SUMMARY OF THE INVENTION

### Technical Problem

However, although low-profile, secondary batteries that are commonly used at present are made up of layers, not all of which are light-transmissive. Thus, light is completely blocked by the batteries as a whole. Therefore, for a notebook computer, for example, it has been necessary to mount a battery in a place that is invisible to the user, such as behind a keyboard. In addition, when a battery is mounted on goggles or eyeglasses, it has been necessary to carry the battery component separately if it is not fit within the frames of the goggles or eyeglasses. Further, furniture such as a lighting fixture made of stained glass as a whole has no space for accommodating a battery. Thus, it has been necessary to secure electricity from an externally exposed cord.

As described above, when a conventional secondary battery is mounted on an electronic device, there has been a problem of a place where the battery is installed or accommodated being limited to a place that is invisible to the user so that the battery will not spoil the appearance or design of the electronic device or will not interfere with the user's view. In addition, another problem has been that for furniture having no space for accommodating a battery, it is necessary to secure electricity from an externally exposed cord.

It is conceivable that a battery, if it is transparent, can be disposed in a wider range of places, such as on the front face of a monitor, and can be even used for a device that has been difficult to have a battery disposed therein for design reasons.

Conventionally, transparent solar cells have been reported (Non-Patent Literature 1) as a battery that does not block light even when disposed on a window. Non-Patent Literature 1 discloses cells for which a transparent semiconductor that absorbs ultraviolet light is used, and such cells are intended to be disposed in a portion to be irradiated with light, such as on a window. Therefore, such transparent solar cells are not suitable for electronic devices that are used indoors and thus are not irradiated with ultraviolet light, for example.

An object of the present invention, which has been made in view of the foregoing, is to provide a light-transmissive battery that transmits visible light.

### Means for Solving the Problem

A light-transmissive battery according to the present invention includes a positive electrode including a positive-electrode current collector layer and a positive electrode layer sequentially stacked over a first insulating transparent cover body; a negative electrode including a negative-electrode current collector layer and a negative electrode layer sequentially stacked over a second insulating transparent cover body; and a transparent electrolyte layer arranged between the positive electrode layer and the negative electrode layer that are opposed to each other, in which each of the positive-electrode current collector layer, the negative-electrode current collector layer, the positive electrode layer, and the negative electrode layer has a thickness that suppresses absorption of visible light among incident light and promotes transmission of the visible light through the layer.

Electricity-generating glass according to the present invention includes two sheets of glass bonded together, and the aforementioned light-transmissive battery disposed between bonding faces of the two sheets of glass.

### Effects of the Invention

According to the present invention, a light-transmissive battery that transmits visible light can be provided.

### BRIEF DESCRIPTION OF DRAWINGS

FIG. 1 is a cross-sectional view schematically illustrating the structure of a light-transmissive battery of the present embodiment.

FIG. 2 is a perspective view schematically illustrating the structure of the light-transmissive battery of the present embodiment.

FIG. 3 is a perspective view schematically illustrating the configuration of another light-transmissive battery of the present embodiment.

FIG. 4 is a perspective view schematically illustrating the configuration of further another light-transmissive battery of the present embodiment.

FIG. 5 illustrates a view in which electrodes of the light-transmissive battery of the present embodiment are bonded together.

FIG. 6 is a graph illustrating the transmittance spectrum of a light-transmissive battery of Example 1.

FIG. 7 is a graph illustrating charge and discharge curves obtained by starting a test by charging the light-transmissive battery of Example 1.

FIG. 8 is a graph illustrating the cycle characteristics of the light-transmissive battery of Example 1.

### DESCRIPTION OF EMBODIMENTS

Hereinafter, an embodiment of the present invention will be described with reference to the drawings.

### Configuration of Light-Transmissive Battery

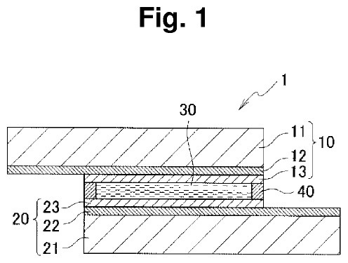

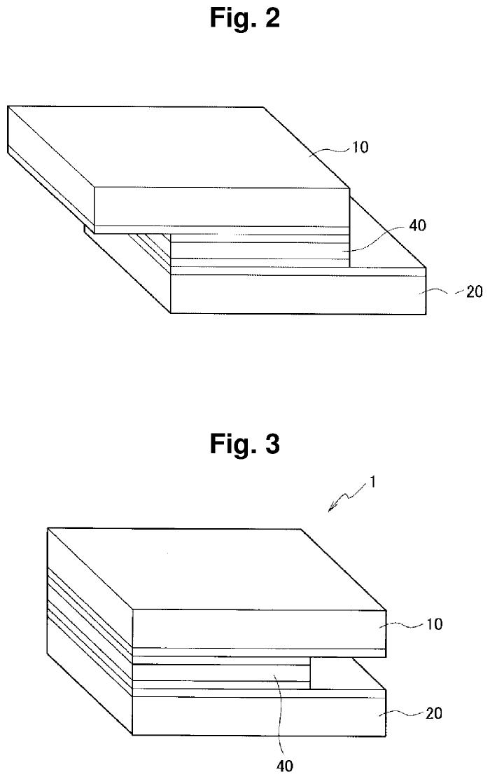

FIG. 1 is a cross-sectional view schematically illustrating the structure of a light-transmissive battery of the present embodiment. FIG. 2 is a perspective view schematically illustrating the structure of the light-transmissive battery of the present embodiment.

A light-transmissive battery 1 of the present embodiment includes at least a positive electrode 10 having a transparent cover body 11 and a positive-electrode current collector layer 12 and a positive electrode layer 13 sequentially stacked over the transparent cover body 11; a negative electrode 20 having a transparent cover body 21 and a negative-electrode current collector layer 22 and a negative electrode layer 23 sequentially stacked over the transparent cover body 21; an electrolyte 30; and an insulating adhesive 40. The positive electrode layer 13 and the negative electrode layer 23 are arranged facing each other across the electrolyte 30 so that they do not contact each other. The insulating adhesive 40 seals the battery so that the electrolyte 30 contacts the positive electrode layer 13 and the negative electrode layer 23. The positive electrode 10 has a current collector tab 12a that is an exposed portion of the positive-electrode current collector layer 12. The negative electrode 20 has a current collector tab 22a that is an exposed portion of the negative-electrode current collector layer 22.

Conventional batteries have been designed in terms of the performance and safety. Electrodes of the conventional batteries each include a metallic current collector layer and a slurry or paste-like composite layer, which contains a mixture of an active material, a conductive agent, and a binder, formed thereon. Such an electrode structure is typically black in color and does not transmit light. To allow a battery to have light transmissivity, it is necessary to suppress absorption and scattering of incident light.

In the present embodiment, each current collector layer is formed to a thickness of 100 to 300 nm, each of the positive electrode layer and the negative electrode layer is formed to a thickness of less than or equal to 200 nm, each of the positive electrode layer and the negative electrode layer is formed in a single layer (i.e., is not mixed with a conductive agent or a binder), and the front surface of each of the positive electrode layer and the negative electrode layer is made planar. Accordingly, the battery is allowed to have light transmissivity.

The material and thickness of each of the transparent cover bodies 11 and 21 are not limited to particular ones as long as an insulating transparent material is used. For example, a transparent glass substrate or plastic substrate can be used.

The positive-electrode current collector layer 12 and the negative-electrode current collector layer 22 are transparent conductive films formed over the transparent cover bodies 11 and 21, respectively, by sputtering, vapor deposition, or spin coating. Examples of the types of the transparent conductive films include semiconductors, such as tin-doped indium oxide (ITO), tin oxide (TO), fluorine-doped tin oxide (FTC)), and zinc oxide (ZnO). The sheet resistance of each transparent conductive film is desirably less than or equal to 100 Ω/sq, and the thickness should be set in the range of 100 to 300 nm. Considering the light transmissivity, each transparent conductive film is desirably an ITO film with a thickness of 100 to 200 nm formed by sputtering.

The positive electrode layer 13 and the negative electrode layer 23 are a single-layer positive electrode layer and a single-layer negative electrode layer, each containing single metal oxide or composite metal oxide, formed over the positive-electrode current collector layer 12 or the negative-electrode current collector layer 22, respectively, by depositing a material containing a substance capable of absorbing and desorbing lithium ions, using sputtering, vapor deposition, or spin coating. Considering the light transmissivity, the thickness of each of the positive electrode layer 13 and the negative electrode layer 23 is desirably thin to suppress absorption of incident light. However, considering the thickness that can obtain a sufficient charge-discharge capacity, the thickness of each layer is desirably in the range of 100 to 200 nm. In addition, to suppress reflection of incident light, unevenness of the front surface of the positive electrode layer 13 or the negative electrode layer 23 is desirably made small, and such layer is desirably formed by sputtering. In this manner, providing the electrode structure that can suppress absorption and reflection of incident light allows the electrode to transmit the incident light.

For the positive electrode layer 13, oxide that can suppress absorption of light and transmit light when deposited thin, such as lithium cobaltate (LiCoO₂), lithium manganate (LiMn₂O₄), lithium iron phosphate (LiFePO₄), or lithium nickelate (LiNiO₂), can be used.

For the negative electrode layer 23, oxide, such as lithium titanate (LoTi₂O₄, Li₄Ti₅O₁₂), titanium oxide (TiO₂), zinc oxide (ZnO), tin oxide (TO), indium oxide (In₂O₃), tin-doped indium oxide (ITO), or fluorine-doped tin oxide (FTC), can be used.

It is acceptable as long as a combination of materials is selected such that the electrode potential of the negative electrode layer 23 becomes lower than that of the positive electrode layer 13.

For the electrolyte 30, an organic electrolytic solution or aqueous electrolytic solution that is transparent and includes dissolved therein a metallic salt containing lithium ions, such as lithium bis(trifluoromethanesulfonyl)imide (LiTFSI), lithium perchlorate (LiClO₄), or lithium hexafluorophosphate (LiPF₆), can be used. As the organic electrolytic solution, the following can be used: a single solvent, such as dimethyl sulfoxide (DMSO), tetraethylene glycol dimethyl ether (TEGDME), dimethyl carbonate (DMC), methyl ethyl carbonate (MEC), methyl propyl carbonate (MPC), methyl isopropyl carbonate (MIPC), methyl butyl carbonate (MBC), diethyl carbonate (DEC), ethyl propyl carbonate (EPC), ethyl isopropyl carbonate (EIPC), ethyl butyl carbonate (EBC), dipropyl carbonate (DPC), diisopropyl carbonate (DIPC), dibutyl carbonate (DBC), ethylene carbonate (EC), propylene carbonate (PC), and 1,2-butylene carbonate (1,2-BC); a mixed solvent of ethylene carbonate (EC) and dimethyl carbonate (DMC) (a volume ratio of 1:1); or a mixed solvent such as EC and diethyl carbonate (DEC). Examples of the aqueous electrolytic solution include an aqueous solution obtained by dissolving a metallic salt containing sodium ions, such as LiClO₄ in water, and a lithium ion conductive liquid (hydrate melt) obtained by mixing a lithium salt, such as LiTFSI or lithium bis(pentafluoroethanesulfonyl)imide (LiBETI), in a very small amount of water.

The insulating adhesive 40 bonds the positive electrode 10 and the negative electrode 20 together as well as covers the periphery of the electrolyte 30 and thus prevents the contact between the electrolyte 30 and the atmosphere. The insulating adhesive 40 is desirably a room-temperature curable synthetic adhesive, such as a solution-dry-type adhesive, a moisture curable adhesive, a two-liquid mixed adhesive, or a UV-curable adhesive. To secure a degree of transparency after curing, a silicone resin adhesive or an epoxy resin adhesive is desirably used. Among them, an epoxy resin adhesive, which has a high adhesive force and high airtightness, low permeability to oxygen and moisture, and high durability against various chemical substances, is desirably used. In particular, for an organic electrolytic solution, an epoxy resin adhesive, which has higher durability, is desirably used.

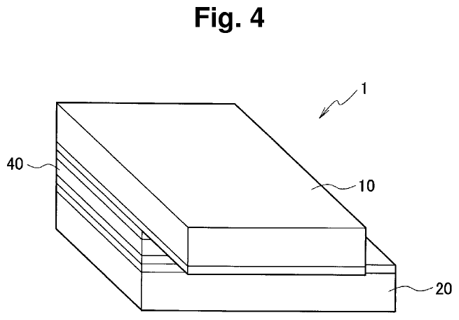

It should be noted that the present invention is not limited to the components or elements illustrated herein, and can be implemented by appropriately changing them within the spirit and scope of the present invention. The shape of each substrate is not limited to that illustrated in the examples, and other shapes, such as a circular shape and a polygonal shape, can also be used. For example, as illustrated in FIG. 3, the current collector tabs of the positive electrode 10 and the negative electrode 20 may be arranged facing each other, or as illustrated in FIG. 4, the current collector tabs of the positive electrode 10 and the negative electrode 20 may be arranged at right angles to each other.

The light-transmissive battery 1 with the aforementioned configuration may be provided between faces, which are bonded together, of two sheets of glass so that electricity-generating glass with a battery function may be formed.

### Examples of Light-Transmissive Battery

Examples of the light-transmissive battery 1 of the present embodiment will be described below in which lithium cobaltate (LiCoO₂) is used for the positive electrode layer 13, lithium titanate (Li₄Ti₅O₁₂) is used for the negative electrode layer 23, and methyl propyl carbonate (MPC) and lithium bis(trifluoromethanesulfonyl)imide (LiTFSI) dissolved therein are used for the electrolyte 30.

### Example 1

First, production of the positive electrode 10 and the negative electrode 20 will be described.

Alkali-free glass with a thickness of 0.7 mm and a size of 20×30 mm was used for each of the transparent cover bodies 11 and 21.

Each of the positive-electrode current collector layer 12 and the negative-electrode current collector layer 22 was obtained by depositing an ITO target over the entire surface on one side of each of the transparent cover bodies 11 and 21 by sputtering. Each of the positive-electrode current collector layer 12 and the negative-electrode current collector layer 22 was formed to a thickness of 200 nm.

The positive electrode layer 13 was obtained by depositing a LiCoO₂ target on a part of the front surface of the positive-electrode current collector layer 12 by sputtering. The negative electrode layer 23 was obtained by depositing a Li₄Ti₅O₁₂ target on a part of the front surface of the negative-electrode current collector layer 22 by sputtering. Each of the positive electrode layer 13 and the negative electrode layer 23 was formed to a thickness of 100 nm. Among a front surface region with a size of 20×30 mm of each of the positive-electrode current collector layer 12 and the negative-electrode current collector layer 22, an end region with a size of 20×10 mm was masked so that the positive electrode layer 13 or the negative electrode layer 23 was formed on the remaining front surface region with a size of 20×20 mm of the positive-electrode current collector layer 12 and the negative-electrode current collector layer 22. The exposed portions of the positive-electrode current collector layer 12 and negative-electrode current collector layer 22, which have no positive electrode layer 13 and negative electrode layer 23 formed thereon, became the current collector tabs 12a and 22a, respectively.

The average transmissivities of the obtained positive electrode 10 (LiCoO₂/ITO/glass) and negative electrode 20 (Li₄Ti₅O₁₂/ITO/glass) with respect to light in the visible range were found to be 30% and 80%, respectively.

Next, production of the light-transmissive battery 1 will be described.

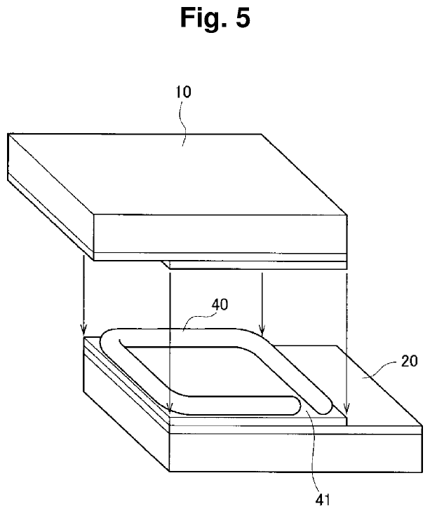

As illustrated in FIG. 5, the insulating adhesive 40 was arranged around the opposed faces of the positive electrode layer 13 and the negative electrode layer 23, and the positive electrode and the negative electrode 20 were bonded together while leaving a gap of 0.5 mm between the positive electrode layer 13 and the negative electrode layer 23. At this time, the insulating adhesive 40 was not arranged around a part (about 1 mm) of the opposed faces of the positive electrode layer 13 and the negative electrode layer 23, so that an electrolytic-solution injection port 41 was provided.

For the insulating adhesive 40, epoxy resin as a two-liquid room-temperature curable adhesive was used. It was confirmed that curing occurred in about 60 minutes after the mixture of the two liquids, and the color of the cured resin was pale yellow and translucent. 1 mol/l of a transparent LiTFSI/PC solution was injected as the electrolyte 30 through the electrolytic-solution injection port 41, and then, the electrolytic-solution injection port 41 was sealed with the insulating adhesive 40 similar to that described above. Then, the insulating adhesive 40 was cured overnight, so that the light-transmissive battery 1 of Example 1 was obtained.

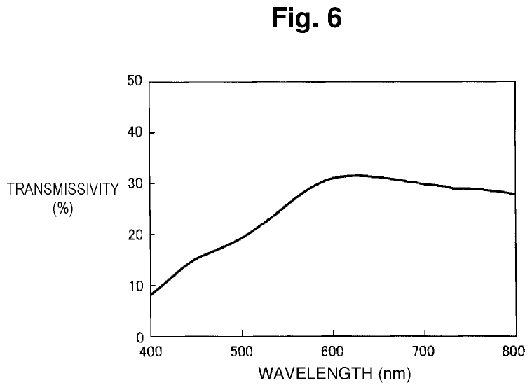

FIG. 6 illustrates the transmittance spectrum of the light-transmissive battery 1 of Example 1. The average transmissivity of the battery in the visible range is 25%, and the battery was also confirmed to have light transmissivity through visual observation. As an example of the index of transmissivity, when a case of using common sunglasses is considered, for example, the transmissivity of the battery is desirably greater than or equal to about 20% in order to allow the other side of the battery to be seen through.

Next, evaluation of the charge and discharge performance of the light-transmissive battery 1 will be described.

A charge-discharge test for the light-transmissive battery 1 was conducted at room temperature by supplying a current thereto at a current density of 1 μA/cm² per effective area of each of the positive electrode layer 13 and the negative electrode layer 23, using a commercially available charge and discharge measurement system (e.g., an SD8 charge and discharge system manufactured by HOKUTO DENKO CORPORATION).

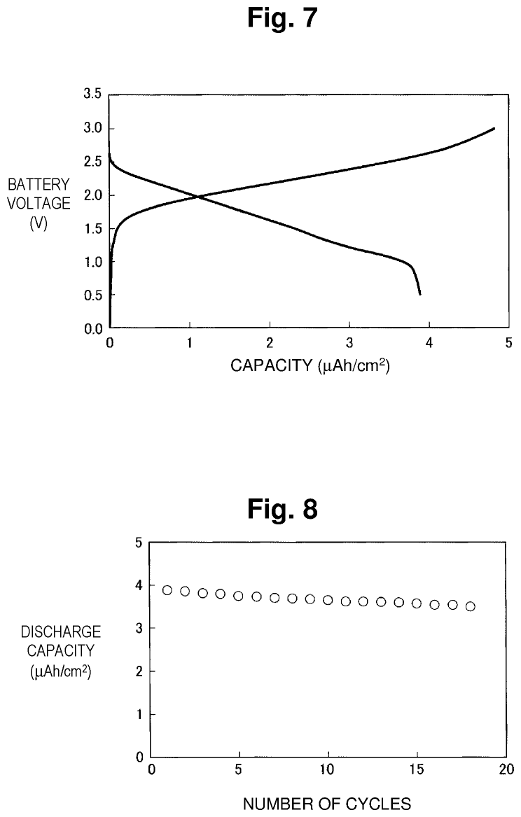

FIG. 7 illustrates charge and discharge curves obtained by starting the test by charging the light-transmissive battery of Example 1. From FIG. 7, it is found that the light-transmissive battery 1 of Example 1 is chargeable and dischargeable, the initial discharge capacity was 3.9 μAh/cm², and the discharge start voltage was 2.5 V.

FIG. 8 illustrates the cycle characteristics of the light-transmissive battery 1 of Example 1. From FIG. 8, it is found that 90% or more of the initial discharge capacity was maintained in the 18-th cycle.

As described above, the light-transmissive battery 1 of Example 1 is found to be reversibly chargeable and dischargeable and have a certain degree of cycle stability.

Described hereinafter are examples based on Example 1, specifically, Examples 2 to 5 obtained by changing the material of each of the positive-electrode current collector layer 12 and the negative-electrode current collector layer 22, Examples 6 to 10 obtained by changing the thickness of each of the positive-electrode current collector layer 12 and the negative-electrode current collector layer 22, and Examples 11 to 15 obtained by changing the thickness of each of the positive electrode layer 13 and the negative electrode layer 23.

First, Examples 2 to 5 obtained by changing the material of each of the positive-electrode current collector layer 12 and the negative-electrode current collector layer 22 will be described.

### Example 2

As the positive-electrode current collector layer 12 and the negative-electrode current collector layer 22 of Example 2, transparent conductive films were formed by depositing FTO over the entire surfaces on one side of the transparent cover bodies 11 and 21, respectively, by sputtering as in Example 1. The thickness of each of the positive-electrode current collector layer 12 and the negative-electrode current collector layer 22 is 200 nm as in Example 1. Other than that, a battery was produced through the same procedures as in Example 1, and the charge and discharge performance was evaluated.

The average transmissivity of the obtained battery in the visible range was 19%, which is lower than that of Example 1 by 6%. The initial discharge capacity was 3.5 μAh/cm², and the discharge start voltage was 2.4 V. 98% of the initial discharge capacity was maintained in the 18-th cycle, thus exhibiting excellent cycle characteristics. The results show that the battery of Example 2 formed using FTO for each of the positive-electrode current collector layer 12 and the negative-electrode current collector layer 22 also operates as a light-transmissive battery.

### Example 3

As the positive-electrode current collector layer 12 and the negative-electrode current collector layer 22 of Example 3, transparent conductive films were formed by depositing a stack of FTO(50 nm)/ITO(150 nm) over the entire surfaces on one side of the transparent cover bodies 11 and 21, respectively, by sputtering as in Example 1. ITO was deposited on the side of the transparent cover bodies 11 and 21, and FTO was deposited on the side of the positive electrode layer 13 and the negative electrode layer 23. The thickness of each of the positive-electrode current collector layer 12 and the negative-electrode current collector layer 22 is 200 nm as in Example 1. Other than that, a battery was produced through the same procedures as in Example 1, and the charge and discharge performance was evaluated.

The average transmissivity of the obtained battery in the visible range was 23%. The initial discharge capacity was 3.8 μAh/cm², and the discharge start voltage was 2.5 V, which are about the same levels as in Example 1. 98% of the initial discharge capacity was maintained in the 18-th cycle, thus exhibiting excellent cycle characteristics. The results show that the battery of Example 3 formed using a stack of FTO/ITO for each of the positive-electrode current collector layer 12 and the negative-electrode current collector layer 22 also operates as a light-transmissive battery.

### Example 4

As the positive-electrode current collector layer 12 and the negative-electrode current collector layer 22 of Example 4, transparent conductive films were formed by depositing SnO₂ over the entire surfaces on one side of the transparent cover bodies 11 and 21, respectively, by sputtering as in Example 1. The thickness of each of the positive-electrode current collector layer 12 and the negative-electrode current collector layer 22 is 200 nm as in Example 1. Other than that, a battery was produced through the same procedures as in Example 1, and the charge and discharge performance was evaluated.

The average transmissivity of the obtained battery in the visible range was 19%. The initial discharge capacity was 3.0 μAh/cm², and the discharge start voltage was 2.3 V, and thus, both the capacity and voltage were lower than the results of Example 1. 85% of the initial discharge capacity was maintained in the 18-th cycle. The results show that the battery of Example 4 formed using SnO₂ for each of the positive-electrode current collector layer 12 and the negative-electrode current collector layer 22 operates as a light-transmissive battery, though its performance is inferior to that of Example 1.

### Example 5

As the positive-electrode current collector layer 12 and the negative-electrode current collector layer 22 of Example 5, transparent conductive films were formed by depositing ZnO over the entire surfaces on one side of the transparent cover bodies 11 and 21, respectively, by sputtering as in Example 1. The thickness of each of the positive-electrode current collector layer 12 and the negative-electrode current collector layer 22 is 200 nm as in Example 1. Other than that, a battery was produced through the same procedures as in Example 1, and the charge and discharge performance was evaluated.

The average transmissivity of the obtained battery in the visible range was 22%. The initial discharge capacity was 3.1 μAh/cm², and the discharge start voltage was 2.1 V, and thus, both the capacity and voltage were lower than the results of Example 1. 80% of the initial discharge capacity was maintained in the 18-th cycle. The results show that the battery of Example 5 formed using ZnO for each of the positive-electrode current collector layer 12 and the negative-electrode current collector layer 22 operates as a light-transmissive battery, though its performance is inferior to that of Example 1.

Table 1 below illustrates the results of evaluation of Examples 1 to 5.

TABLE 1

| | | | Thickness (nm) | | | | Retention |
|---|---|---|---|---|---|---|---|
| | | Thickness | of Positive | Average | Initial Cycle | | Rate (%) of |
| | | (nm) of | Electrode | Transmissivity | Discharge | | Discharge |
| | Current | Current | Layer and | (%) of Battery | Start | Discharge | Capacity |
| | Collector | Collector | Negative | in Visible | Voltage | Capacity | in 18-th |
| Example | Layer | Layer | Electrode Layer | Range | (V) | (μAh/cm²) | Cycle |
| Example 1 | ITO | 200 | 100 | 25 | 2.5 | 3.9 | 91 |
| Example 2 | FTO | 200 | 100 | 19 | 2.4 | 3.5 | 98 |
| Example 3 | FTO/ITO | FTO 50 | 100 | 23 | 2.5 | 3.8 | 98 |
| | | ITO 150 | | | | | |
| Example 4 | SnO₂ | 100 | 100 | 19 | 2.3 | 3.0 | 85 |
| Example 5 | ZnO | 100 | 100 | 22 | 2.1 | 3.1 | 80 |

From the results of evaluation of Examples 1 to 5, it was confirmed that light transmissivity is the highest when ITO is used, and durability is the highest when a stack of FTO/ITO is used. Since FTO has higher resistance to chemicals than ITO, a structure in which FTO layers are provided in the positive-electrode current collector layer 12 and negative-electrode current collector layer 22 on the side in contact with the positive electrode layer 13 and the negative electrode layer 23, respectively, has higher durability than a structure having a single ITO layer.

Next, regarding a case where ITO, which exhibited the highest average transmissivity of Examples 1 to 5, is used for each of the positive-electrode current collector layer 12 and the negative-electrode current collector layer 22, Examples 6 to 10 will be described in which the influence of the thickness of each of the positive-electrode current collector layer 12 and the negative-electrode current collector layer 22 was inspected.

### Example 6

The thickness of ITO for each of the positive-electrode current collector layer 12 and the negative-electrode current collector layer 22 was set to 20 nm. Other than that, a battery was produced through the same procedures as in Example 1, and the charge and discharge performance was evaluated.

The average transmissivity of the obtained battery in the visible range was 35%. The initial discharge capacity was 2.0 μAh/cm², and the discharge start voltage was 1.5 V.

### Example 7

The thickness of ITO for each of the positive-electrode current collector layer 12 and the negative-electrode current collector layer 22 was set to 50 nm. Other than that, a battery was produced through the same procedures as in Example 1, and the charge and discharge performance was evaluated.

The average transmissivity of the obtained battery in the visible range was 32%. The initial discharge capacity was 2.5 μAh/cm², and the discharge start voltage was 1.7 V.

### Example 8

The thickness of ITO for each of the positive-electrode current collector layer 12 and the negative-electrode current collector layer 22 was set to 100 nm. Other than that, a battery was produced through the same procedures as in Example 1, and the charge and discharge performance was evaluated.

The average transmissivity of the obtained battery in the visible range was 30%. The initial discharge capacity was 3.5 μAh/cm², and the discharge start voltage was 2.3 V.

### Example 9

The thickness of ITO for each of the positive-electrode current collector layer 12 and the negative-electrode current collector layer 22 was set to 300 nm. Other than that, a battery was produced through the same procedures as in Example 1, and the charge and discharge performance was evaluated.

The average transmissivity of the obtained battery in the visible range was 22%. The initial discharge capacity was 4.8 μAh/cm², and the discharge start voltage was 2.7 V.

### Example 10

The thickness of ITO for each of the positive-electrode current collector layer 12 and the negative-electrode current collector layer 22 was set to 500 nm. Other than that, a battery was produced through the same procedures as in Example 1, and the charge and discharge performance was evaluated.

The average transmissivity of the obtained battery in the visible range was 9%. The initial discharge capacity was 5.0 μAh/cm², and the discharge start voltage was 2.9 V.

Table 2 below illustrates the results of evaluation of Examples 6 to 10. Table 2 also illustrates the results of evaluation of Example 1.

TABLE 2

| | | | Thickness (nm) | | | |
|---|---|---|---|---|---|---|
| | | Thickness | of Positive | Average | Initial Cycle | |
| | | (nm) of | Electrode | Transmissivity | Discharge | |
| | Current | Current | Layer and | (%) of Battery | Start | Discharge |
| | Collector | Collector | Negative | in Visible | Voltage | Capacity |
| Example | Layer | Layer | Electrode Layer | Range | (V) | (μAh/cm²) |
| Example 1 | ITO | 200 | 100 | 25 | 2.5 | 3.9 |
| Example 6 | ITO | 20 | 100 | 35 | 1.5 | 2.0 |
| Example 7 | ITO | 50 | 100 | 32 | 1.7 | 2.5 |
| Example 8 | ITO | 100 | 100 | 30 | 2.3 | 3.5 |
| Example 9 | ITO | 300 | 100 | 22 | 2.7 | 4.8 |
| Example 10 | ITO | 500 | 100 | 9 | 2.9 | 5.0 |

The results of evaluation of Examples 6 to 10 show that the thinner the layer is, the higher the transmissivity, but the discharge capacity decreases. This is considered to be because a reduction in the thickness of the current collector resulted in increased resistance of the current collector, which thus resulted in decreased electrical conductivity. In each of Examples 6 and 7 in which the thickness of each current collector is less than 100 nm, discharge capacity is low, while in Example 10 in which the thickness of each current collector is greater than 300 nm, transmissivity is low. To maintain a transmissivity of greater than or equal to 20% at which transmission of light can be fully visually recognized, and to secure excellent battery performance, it is considered that an appropriate thickness of each of the positive-electrode current collector layer 12 and negative-electrode current collector layer 22 for which ITO is used is 100 to 300 nm. It is also considered that an appropriate thickness of each of the positive-electrode current collector layer 12 and the negative-electrode current collector layer 22 for which other materials are used is 100 to 300 nm.

Next, regarding a case where ITO with a thickness of 200 nm, which is the same thickness of ITO of Example 1, is used for each of the positive-electrode current collector layer 12 and the negative-electrode current collector layer 22, Examples 11 to 15 will be described in which the influence of the thickness of each of the positive electrode layer 13 and the negative electrode layer 23 was inspected.

### Example 11

The thickness of each of the positive electrode layer 13 and the negative electrode layer 23 was set to 50 nm. Other than that, a battery was produced through the same procedures as in Example 1, and the charge and discharge performance was evaluated.

The average transmissivity of the obtained battery in the visible range was 42%. The initial discharge capacity was 2.9 μAh/cm², and the discharge start voltage was 2.9 V.

### Example 12

The thickness of each of the positive electrode layer 13 and the negative electrode layer 23 was set to 150 nm. Other than that, a battery was produced through the same procedures as in Example 1, and the charge and discharge performance was evaluated.

The average transmissivity of the obtained battery in the visible range was 21%. The initial discharge capacity was 4.0 μAh/cm², and the discharge start voltage was 2.3 V.

### Example 13

The thickness of each of the positive electrode layer 13 and the negative electrode layer 23 was set to 200 nm. Other than that, a battery was produced through the same procedures as in Example 1, and the charge and discharge performance was evaluated.

The average transmissivity of the obtained battery in the visible range was 17%. The initial discharge capacity was 4.1 μAh/cm², and the discharge start voltage was 2.1 V.

### Example 14

The thickness of each of the positive electrode layer 13 and the negative electrode layer 23 was set to 300 nm. Other than that, a battery was produced through the same procedures as in Example 1, and the charge and discharge performance was evaluated.

The average transmissivity of the obtained battery in the visible range was 8%. The initial discharge capacity was 3.5 μAh/cm², and the discharge start voltage was 1.6 V.

### Example 15

The thickness of each of the positive electrode layer 13 and the negative electrode layer 23 was set to 500 nm. Other than that, a battery was produced through the same procedures as in Example 1, and the charge and discharge performance was evaluated.

The average transmissivity of the obtained battery in the visible range was 3%. The initial discharge capacity was 3.3 μAh/cm², and the discharge start voltage was 1.2 V.

Table 3 below illustrates the results of evaluation of Examples 11 to 15. Table 3 also illustrates the results of evaluation of Example 1.

TABLE 3

| | | | Thickness (nm) | | | |
|---|---|---|---|---|---|---|
| | | Thickness | of Positive | Average | Initial Cycle | |
| | | (nm) of | Electrode | Transmissivity | Discharge | |
| | Current | Current | Layer and | (%) of Battery | Start | Discharge |
| | Collector | Collector | Negative | in Visible | Voltage | Capacity |
| Example | Layer | Layer | Electrode Layer | Range | (V) | (μAh/cm²) |
| Example 1 | ITO | 200 | 100 | 25 | 2.5 | 3.9 |
| Example 11 | ITO | 200 | 50 | 42 | 2.9 | 2.9 |
| Example 12 | ITO | 200 | 150 | 21 | 2.3 | 4.0 |
| Example 13 | ITO | 200 | 200 | 17 | 2.1 | 4.1 |
| Example 14 | ITO | 200 | 300 | 8 | 1.6 | 3.5 |
| Example 15 | ITO | 200 | 500 | 3 | 1.2 | 3.3 |

From the results of evaluation of Examples 11 to 13, it was confirmed that the thinner the positive electrode layer 13 and the negative electrode layer 23, the higher the transmissivity. Meanwhile, it was shown that the thinner the layers, the higher the discharge start voltage and the lower the discharge capacity. It is considered that when the positive electrode layer 13 and the negative electrode layer 23 are thin, the resistance of the layers up to the current collector layers in the thickness direction decreases, but since the amount of the substance consumed for cell reactions decreases, the discharge capacity also decreases.

Further, from the results of evaluation of Examples 14 and 15, it was confirmed that when the thickness of each of the positive electrode layer 13 and the negative electrode layer 23 is greater than or equal to 300 nm, both the transmissivity and discharge start voltage significantly decrease. The voltage drops due to the IR resistance (loss) for the amount of the thickness of the electrode with low conductivity.

From the above results, it is considered that to maintain the transmissivity at which transmission of light can be fully visually recognized, and to secure excellent battery performance, an appropriate thickness of each of the positive electrode layer 13 and the negative electrode layer 23 is 50 to 200 nm. It is also considered that when materials other than ITO are used for each of the positive-electrode current collector layer 12 and the negative-electrode current collector layer 22, an appropriate thickness of each of the positive electrode layer 13 and the negative electrode layer 23 is similarly 50 to 200 nm.

As described above, according to the present embodiment, the light-transmissive battery 1 includes the positive electrode having the insulating transparent cover body 11 and the positive-electrode current collector layer 12 and the positive electrode layer 13 sequentially stacked over the insulating transparent cover body 11; the negative electrode 20 having the insulating transparent cover body 21 and the negative-electrode current collector layer 22 and the negative electrode layer 23 sequentially stacked over the insulating transparent cover body 21; and the transparent electrolyte 30 arranged between the positive electrode layer 13 and the negative electrode layer 23 that are opposed to each other. In addition, according to the present embodiment, each of the positive-electrode current collector layer 12, the negative-electrode current collector layer 22, the positive electrode layer 13, and the negative electrode layer 23 is formed to a thickness that allows the layer to transmit visible light. Thus, according to the present embodiment, the light-transmissive battery 1 that transmits visible light can be provided. When the light-transmissive battery 1 of the present embodiment is mounted on an electronic device, advantageous effects are provided in that the flexibility of the position for disposing or accommodating the battery is increased, and the appearance or design of the device is not spoiled. In particular, an advantageous effect is provided in that the battery can be mounted on a transparent device with high compatibility.

### REFERENCE SIGNS LIST

1 Light-transmissive battery
10 Positive electrode
11 Transparent cover body
12 Positive-electrode current collector layer
12a Current collector tab
13 Positive electrode layer
20 Negative electrode
21 Transparent cover body
22a Current collector tab
22 Negative-electrode current collector layer
23 Negative electrode layer
30 Electrolyte
40 Insulating adhesive
41 Electrolytic-solution injection port

1. A light-transmissive battery comprising:
a positive electrode including a positive-electrode current collector layer and a positive electrode layer sequentially stacked over a first insulating transparent cover body;
a negative electrode including and a negative-electrode current collector layer and a negative electrode layer sequentially stacked over a second insulating transparent cover body; and
a transparent electrolyte layer arranged between the positive electrode layer and the negative electrode layer that are opposed to each other,
wherein:
each of the positive-electrode current collector layer, the negative-electrode current collector layer, the positive electrode layer, and the negative electrode layer has a thickness that suppresses absorption of visible light among incident light and promotes transmission of the visible light through the layer.

2. The light-transmissive battery according to claim 1, wherein each of the positive electrode layer and the negative electrode layer has a thickness in a range of 50 to 200 nm and is a single layer of single metal oxide or composite metal oxide containing a substance capable of absorbing and desorbing lithium ions.

3. The light-transmissive battery according to claim 1, wherein each of the positive-electrode current collector layer and the negative-electrode current collector layer has a thickness in a range of 100 to 300 nm, and is a transparent conductive film containing at least one of tin-doped indium oxide, tin oxide, fluorine-doped tin oxide, or zinc oxide.

4. The light-transmissive battery according to claim 1, wherein the electrolyte layer is an aqueous electrolytic solution or an organic electrolytic solution.

5. The light-transmissive battery according to claim 1, comprising:
an insulating adhesive arranged around the electrolyte layer, the insulating adhesive being adapted to bond the positive electrode and the negative electrode together;
a first current collector tab that is an exposed portion of the positive-electrode current collector layer; and
a second current collector tab that is an exposed portion of the negative-electrode current collector layer.

6. An electricity-generating glass comprising:
two sheets of glass bonded together; and
the light-transmissive battery according to claim 1, the light-transmissive battery being disposed between bonding faces of the two sheets of glass.

7. The light-transmissive battery according to claim 2, wherein each of the positive-electrode current collector layer and the negative-electrode current collector layer has a thickness in a range of 100 to 300 nm, and is a transparent conductive film containing at least one of tin-doped indium oxide, tin oxide, fluorine-doped tin oxide, or zinc oxide.

8. The light-transmissive battery according to claim 2, wherein the electrolyte layer is an aqueous electrolytic solution or an organic electrolytic solution.

9. The light-transmissive battery according to claim 3, wherein the electrolyte layer is an aqueous electrolytic solution or an organic electrolytic solution.

10. The light-transmissive battery according to claim 2, comprising:
an insulating adhesive arranged around the electrolyte layer, the insulating adhesive being adapted to bond the positive electrode and the negative electrode together;
a first current collector tab that is an exposed portion of the positive-electrode current collector layer; and
a second current collector tab that is an exposed portion of the negative-electrode current collector layer.

11. The light-transmissive battery according to claim 3, comprising:
an insulating adhesive arranged around the electrolyte layer, the insulating adhesive being adapted to bond the positive electrode and the negative electrode together;
a first current collector tab that is an exposed portion of the positive-electrode current collector layer; and
a second current collector tab that is an exposed portion of the negative-electrode current collector layer.

12. The light-transmissive battery according to claim 4, comprising:
an insulating adhesive arranged around the electrolyte layer, the insulating adhesive being adapted to bond the positive electrode and the negative electrode together;
a first current collector tab that is an exposed portion of the positive-electrode current collector layer; and
a second current collector tab that is an exposed portion of the negative-electrode current collector layer.

13. An electricity-generating glass comprising:
two sheets of glass bonded together; and
the light-transmissive battery according to claim 2, the light-transmissive battery being disposed between bonding faces of the two sheets of glass.

14. An electricity-generating glass comprising:
two sheets of glass bonded together; and
the light-transmissive battery according to claim 3, the light-transmissive battery being disposed between bonding faces of the two sheets of glass.

15. An electricity-generating glass comprising:
two sheets of glass bonded together; and
the light-transmissive battery according to claim 4, the light-transmissive battery being disposed between bonding faces of the two sheets of glass.

16. An electricity-generating glass comprising:
two sheets of glass bonded together; and
the light-transmissive battery according to claim 5, the light-transmissive battery being disposed between bonding faces of the two sheets of glass.
